(19) United States
(12) Patent Application Publication
(10) Pub. No.: US 2015/0317631 A1
(43) Pub. Date: Nov. 5, 2015

(54) MATCHING PERSONAL PHOTO IMAGES WITH PURCHASE HISTORY

(71) Applicant: MasterCard International Incorporated, Purchase, NY (US)

(72) Inventors: Mary Elizabeth Lesbirel, Holmdel, NJ (US); Debashis Ghosh, Charlotte, NC (US)

(73) Assignee: MasterCard International Incorporated, Purchase, NY (US)

(21) Appl. No.: 14/269,106

(22) Filed: May 3, 2014

(51) Int. Cl. G06Q 20/40

(52) U.S. Cl. CPC G06Q 20/401

(57) ABSTRACT

At a photo server, a payment card account number is obtained from a cardholder. At the photo server, access is obtained to a database of payment card transaction information, using the payment card account number. At least one digital photo is putatively matched to a location of at least one transaction for the payment card account number in the database of transaction information, based on at least one of time stamp and geolocation, to obtain a first putative match. An indication of the first putative match is provided to the cardholder.

### FIELD OF THE DISCLOSURE

The present disclosure relates generally to the electronic and computer arts, and, more particularly, to apparatus and methods leveraging electronic payment data.

### BACKGROUND OF THE DISCLOSURE

The use of payment cards, such as credit cards, debit cards, and pre-paid cards, has become ubiquitous. Most payment card accounts have one or more associated physical cards; however, the use of non-traditional payment devices, such as appropriately-configured “smart” cellular telephones, is increasing. A wealth of transaction data is available based on the use of payment card accounts.

Digital cameras have become common among consumers, and the vast majority of smartphones include integrated digital cameras.

### SUMMARY OF THE DISCLOSURE

Principles of the disclosure provide techniques for matching personal photo images with purchase history. In one aspect, an exemplary method includes the steps of obtaining, at a photo server, from a cardholder, a payment card account number; obtaining access, at the photo server, to a database of payment card transaction information, using the payment card account number; putatively matching at least one digital photo to a location of at least one transaction for the payment card account number in the database of transaction information, based on at least one of time stamp and geolocation, to obtain a first putative match; and providing to the cardholder an indication of the first putative match.

Aspects of the disclosure contemplate the method(s) performed by one or more entities herein, as well as facilitating one or more method steps by the same or different entities. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the disclosure or elements thereof can be implemented in the form of a computer program product including a tangible computer readable recordable storage medium with computer usable program code for performing the method steps indicated stored thereon in a non-transitory manner. Furthermore, one or more embodiments of the disclosure or elements thereof can be implemented in the form of a system (or apparatus) including a memory and at least one processor that is coupled to the memory and operative to perform exemplary method steps. Yet further, in another aspect, one or more embodiments of the disclosure or elements thereof can be implemented in the form of means for carrying out one or more of the method steps described herein; the means can include (i) specialized hardware module(s), (ii) software module(s) stored in a non-transitory manner in a tangible computer-readable recordable storage medium (or multiple such media) and implemented on a hardware processor, or (iii) a combination of (i) and (ii); any of (i)-(iii) implement the specific techniques set forth herein. Transmission medium(s) per se and disembodied signals per se are defined to be excluded from the claimed means.

One or more embodiments of the disclosure can provide substantial beneficial technical effects; for example, in fraud detection or other security applications.

These and other features and advantages of the present disclosure will become apparent from the following detailed description of illustrative embodiments thereof, which is to be read in connection with the accompanying drawings.

### BRIEF DESCRIPTION OF THE DRAWINGS

FIG. 1 shows an example of a system and various components thereof that can implement techniques of the disclosure;

FIG. 2 depicts an exemplary inter-relationship between and among: (i) a payment network configured to facilitate transactions between multiple issuers and multiple acquirers, (ii) a plurality of users, (iii) a plurality of merchants, (iv) a plurality of acquirers, and (v) a plurality of issuers, as well as an exemplary database, useful in connection with one or more embodiments of the disclosure;

FIG. 3 is a block diagram of an exemplary system, in accordance with an aspect of the disclosure;

FIG. 4 is a block diagram of a “smart” phone or tablet computer useful in one or more embodiments of the disclosure; and

FIG. 5 is a block diagram of an exemplary computer system useful in one or more embodiments of the disclosure.

### DETAILED DESCRIPTION OF PREFERRED EMBODIMENTS

### Payment Devices and Associated Payment Processing Networks

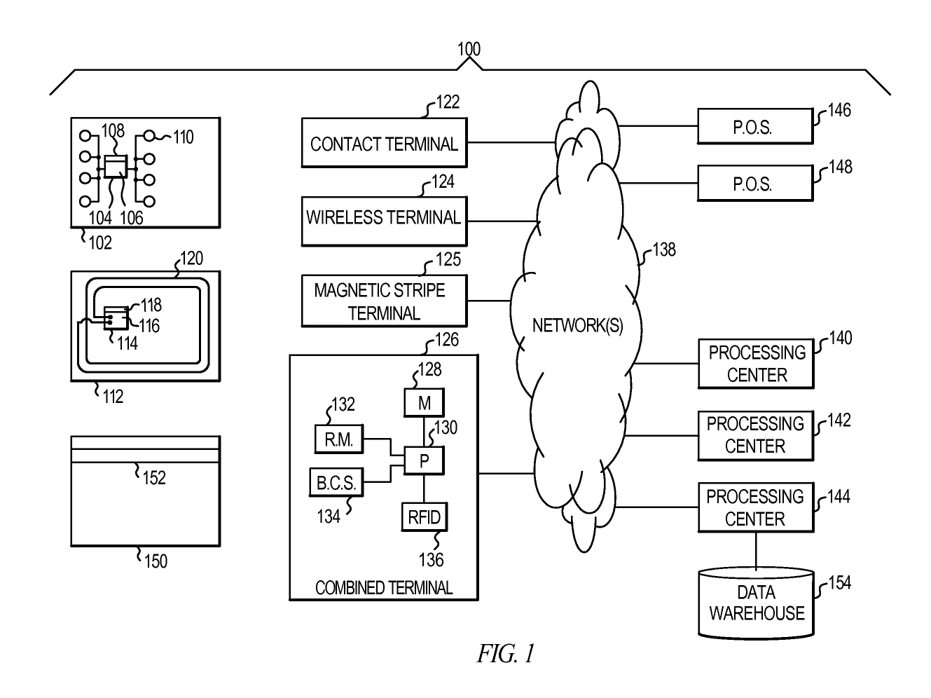

Attention should now be given to FIG. 1, which depicts an exemplary embodiment of a system 100, according to an aspect of the disclosure, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed. The system 100 per se may function with other types of devices in lieu of or in addition to “smart” or “chip” cards 102, 112; for example, a conventional card 150 having a magnetic stripe 152. Furthermore, an appropriately configured mobile device (e.g., “smart” cellular telephone handset, tablet, personal digital assistant (PDA), and the like) can be used to carry out contactless payments in some instances.

The ICs 104, 114 can contain processing units 106, 116 and memory units 108, 118. Preferably, the ICs 104, 114 can also include one or more of control logic, a timer, and input/output ports. Such elements are well known in the IC art and are not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”). The memory portions of units 108, 118 can store the operating system of the cards 102, 112. The operating system loads and executes applications and provides file management or other basic card services to the applications. One operating system that can be used to implement some aspects or embodiments of the present disclosure is the MULTOS® operating system licensed by MAOSCO Limited. (MAOSCO Limited, St. Andrews House, The Links, Kelvin Close, Birchwood, Warrington, Wash.3 7PB, United Kingdom) Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible specification to which such applications may conform is the EMV interoperable payments specification set forth by EMVCo, LLC (901 Metro Center Boulevard, Mailstop M3-3D, Foster City, Calif., 94404, USA). It will be appreciated that applications can be configured in a variety of different ways.

The skilled artisan will also be familiar with the MasterCard® PayPass™ specifications, available under license from MasterCard International Incorporated of Purchase, N.Y., USA (trademarks of MasterCard International Incorporated of Purchase, N.Y., USA).

As noted, cards 102, 112 are examples of a variety of payment devices that can be employed. The primary function of the payment devices may not be payment, for example, they may be cellular phone handsets that implement appropriate techniques. Such devices could include cards having a conventional form factor, smaller or larger cards, cards of different shape, key fobs, personal digital assistants (PDAs), appropriately configured cell phone handsets, or indeed any device with the appropriate capabilities. In some cases, the cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute one or more steps. The applications can be, for example, application identifiers (AIDs) linked to software code in the form of firmware plus data in a card memory such as an electrically erasable programmable read-only memory (EEPROM).

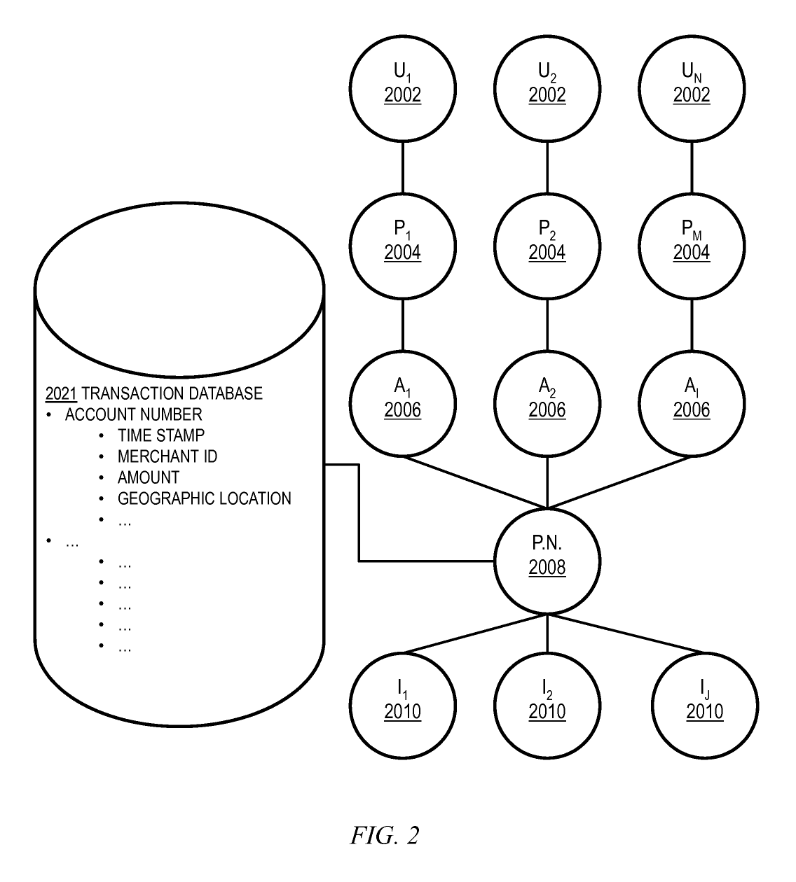

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any combination of devices 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (RFID) tag reader 136. Items 128, 132, 134, 136 can be coupled to the processor 130. Note that the principles of construction of terminal 126 are applicable to other types of terminals and are described in detail for illustrative purposes. Reader module 132 can, in general, be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network (e.g., a virtual private network (VPN) such as is described with respect to FIG. 2 below). More than one network could be employed to connect different elements of the system. For example, a local area network (LAN) could connect a terminal to a local server or other computer at a retail establishment or the like. A payment network could connect acquirers and issuers. Further details regarding one specific form of payment network will be provided below. Processing centers 140, 142, 144 can include, for example, a host computer of an issuer of a payment device.

Many different retail or other establishments, represented by points-of-sale 146, 148, can be connected to network 138. Different types of portable payment devices, terminals, or other elements or components can combine or “mix and match” one or more features depicted on the exemplary devices in FIG. 1.

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform one or more steps of methods and techniques. The processor can perform such operations via hardware techniques, and/or under the influence of program instructions, such as an application, stored in one of the memory units.

The portable device can include a body portion. For example, this could be a laminated plastic body (as discussed above) in the case of “smart” or “chip” cards 102, 112, or the handset chassis and body in the case of a cellular telephone.

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as reader module 132 that is coupled to the processor and configured to interface with the portable apparatuses 102, 112, 150. The processor 130 can be operable to communicate with portable payment devices of a user via the reader module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can optionally be provided, and can be coupled to the processor, to gather attribute data, such as a product identification from a UPC code or RFID tag on a product to be purchased.

The above-described devices 102, 112 can be International Organization for Standardization (ISO) 7816-compliant contact cards or devices or NFC (Near Field Communications) or ISO 14443-compliant proximity cards or devices. In operation, card 112 can be touched or tapped on the wireless terminal 124 or reader module 132 (or an associated reader), which then contactlessly transmits the electronic data to the proximity IC chip in the card 112 or other wireless device.

One or more of the processing centers 140, 142, 144 can include a database such as a data warehouse 154.

With reference to FIG. 2, an exemplary relationship among multiple entities is depicted. A number of different users (e.g., consumers) 2002, U₁, U₂ . . . U_{N}, interact with a number of different merchants 2004, P₁, P₂ . . . P_{M}. Merchants 2004 interact with a number of different acquirers 2006, A₁, A₂ . . . A_{I}. Acquirers 2006 interact with a number of different issuers 2010, I₁, I₂ . . . I_{J}, through, for example, a single operator of a payment network 2008 configured to facilitate transactions between multiple issuers and multiple acquirers; for example, MasterCard International Incorporated, operator of the BANKNET® network, or Visa International Service Association, operator of the VISANET® network. In general, N, M, I, and J are integers that can be equal or not equal.

During a conventional credit authorization process, the consumer 2002 pays for the purchase and the merchant 2004 submits the transaction to the acquirer (acquiring bank) 2006. The acquirer verifies the card number, the transaction type and the amount with the issuer 2010 and reserves that amount of the cardholder's credit limit for the merchant. At this point, the authorization request and response have been exchanged, typically in real time. Authorized transactions are stored in “batches,” which are sent to the acquirer 2006. During subsequent clearing and settlement, the acquirer sends the batch transactions through the payment card network 2008, which debits the issuers 2010 for payment and credits the acquirer 2006. Once the acquirer 2006 has been paid, the acquirer 2006 pays the merchant 2004.

Transaction database 2021 is discussed below.

It will be appreciated that the payment card network 2008 shown in FIG. 2 is an example of a payment network configured to facilitate transactions between multiple issuers and multiple acquirers, which may be thought of as an “open” system. Some embodiments of the disclosure may be employed with other kinds of payment networks, for example, proprietary or closed payments networks with only a single issuer and acquirer. Furthermore in this regard, FIG. 2 depicts a four party model, as will be known to the skilled artisan; the four parties are the consumer 2002, merchant 2004, acquirer 2006, and issuer 2010. However, at least some embodiments are also of use with three-party models, wherein the acquirer and issuer are the same entity.

Messages within a network such as network 138 and/or network 2008, may, in at least some instances, conform to the ISO Standard 8583, Financial transaction card originated messages—Interchange message specifications, which is the ISO standard for systems that exchange electronic transactions made by cardholders using payment cards. It should be noted that the skilled artisan will be familiar with the ISO 8583 standards. Nevertheless, out of an abundance of caution, the following documents are expressly incorporated herein by reference in their entirety for all purposes (published by ISO, Geneva, Switzerland, and available on the ISO web site):
ISO 8583 Part 1: Messages, data elements and code values (2003)
ISO 8583 Part 2: Application and registration procedures for Institution Identification Codes (IIC) (1998)
ISO 8583 Part 3: Maintenance procedures for messages, data elements and code values (2003)
ISO 8583:1993 (1993)
ISO 8583:1987 (1987)

As used herein, a “payment card network” is a communications network that uses payment card account numbers, such as primary account numbers (PANs), to authorize, and to facilitate clearing and settlement of, payment card transactions for credit, debit, stored value and/or prepaid card accounts. The card accounts have standardized payment card account numbers associated with them, which allow for efficient routing and clearing of transactions; for example, ISO standard account numbers such as ISO/IEC 7812-compliant account numbers. The card accounts and/or account numbers may or may not have physical cards or other physical payment devices associated with them. For example, in some instances, organizations have purchasing card accounts to which a payment card account number is assigned, used for making purchases for the organization, but there is no corresponding physical card. In other instances, “virtual” account numbers are employed; this is also known as PAN mapping. The PAN mapping process involves taking the original Primary Account Number (PAN) (which may or may not be associated with a physical card) and issuing a pseudo-PAN (or virtual card number) in its place. Commercially available PAN-mapping solutions include those available from Orbiscom Ltd., Block 1, Blackrock Business Park, Carysfort Avenue, Blackrock, Co. Dublin, Ireland (now part of MasterCard International Incorporated of Purchase, N.Y., USA); by way of example and not limitation, techniques of U.S. Pat. Nos. 6,636,833 and 7,136,835 of Flitcroft et al., the complete disclosures of both of which are expressly incorporated herein by reference in their entireties for all purposes. It is worth noting that in one or more embodiments, single use PANS are only valuable to the extent that they can be re-mapped to the underlying account, cardholder, or household.

Some payment card networks connect multiple issuers with multiple acquirers; others use a three party model. Some payment card networks use ISO 8583 messaging. Non-limiting examples of payment card networks that connect multiple issuers with multiple acquirers are the BANKNET® network and the VISANET® network.

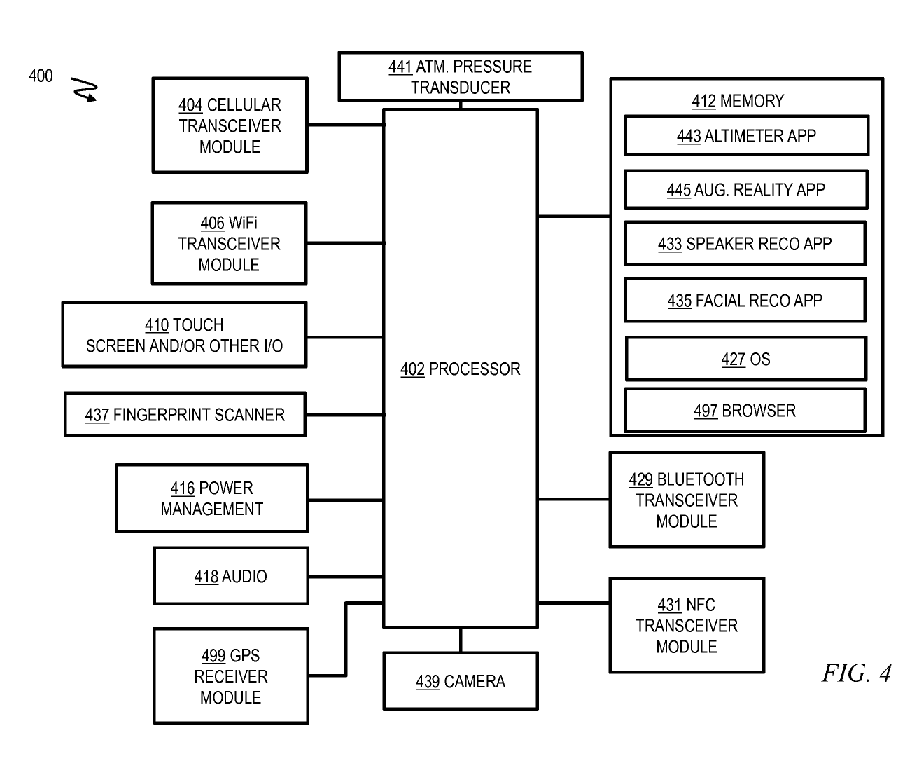

FIG. 4 is a block diagram of an exemplary tablet computing device, netbook, “Ultrabook” or other subnotebook, laptop, mobile electronic device, or smart phone 400 or the like. Unit 400 includes a suitable processor; e.g., a microprocessor 402. A cellular transceiver module 404 coupled to processor 402 includes an antenna and appropriate circuitry to send and receive cellular telephone signals, e.g., 3G or 4G. In some cases, a Wi-Fi transceiver module 406 coupled to processor 402 includes an antenna and appropriate circuitry to allow unit 400 to connect to the Internet via a wireless network access point or hotspot. The skilled artisan will appreciate that “Wi-Fi” is a trademark of the Wi-Fi Alliance and the brand name for products using the IEEE 802.11 family of standards. In some cases, a Bluetooth transceiver module 429 coupled to processor 402 includes an antenna and appropriate circuitry to allow unit 400 to connect to other devices via the Bluetooth wireless technology standard. In some cases, an NFC transceiver module 431 coupled to processor 402 includes an antenna and appropriate circuitry to allow unit 400 to establish radio communication via near-field communications.

Operating system (OS) 427 orchestrates the operation of unit 400. Apple's iOS and Google's Android are non-limiting examples of suitable operating systems.

Touch screen 410 coupled to processor 402 is also generally indicative of a variety of input/output (I/O) devices such as a keypad, another type of display, a mouse or other pointing device, and so on, all of which may or may not be present in one or more embodiments. Audio module 418 coupled to processor 402 includes, for example, an audio coder/decoder (codec), speaker, headphone jack, microphone, and so on. Power management system 416 can include a battery charger, an interface to a battery, and so on. Memory 412 is coupled to processor 402. Memory 412 can include, for example, volatile memory such as RAM, and non-volatile memory such as ROM, flash, or any tangible computer-readable recordable storage medium which stores information in a non-transitory manner. Processor 402 will typically also have on-chip memory.

In some cases, fingerprint scanner 437 is coupled to processor 402 for biometric authentication purposes. An appropriate corresponding software application (not separately depicted) may reside in memory 412 in some instances. A digital camera 439 is coupled to processor 402. In some embodiments, camera 439 is used in conjunction with a facial recognition application 435 in memory 412 for biometric verification. In some embodiments, a microphone in audio module 418 is used in conjunction with a speaker recognition application 433 in memory 412 for biometric verification; a suitable acoustic front end can be provided.

A GPS receiver module 499 coupled to processor 402 includes an antenna and appropriate circuitry to allow device 400 to calculate its position by precisely timing the signals sent by GPS satellites high above the Earth. Corresponding software optionally resides in memory 412.

Memory 412 can also include, for example, a stored PIN for comparison with a PIN entered via touch screen 410; extracted facial features from the legitimate owner of the phone for comparison with facial features extracted from a picture taken by camera 439; extracted fingerprint features from the legitimate owner of the phone for comparison with fingerprint features obtained from a scan carried out by scanner 437; and/or extracted voice features from the legitimate owner of the phone for comparison with voice features extracted from a voice sample obtained from a microphone in audio module 418. Note that elements in FIG. 4 are shown connected directly to processor 402; however, one or more bus structures can be employed in one or more embodiments. Furthermore, elements shown as implemented in software may be implemented at least in part in hardware for speed, if desired.

Browser program 497 in memory 412 deciphers hypertext markup language (html) served out by a server such as 306 (discussed below) for display on screen 410 or the like.

Atmospheric pressure transducer 441 senses atmospheric pressure, which can be converted to altitude by altimeter application 443 using formulas that are, in and of themselves, well-known. Augmented reality application 445 provides an augmented reality experience for the user; pertinent data or other related aspects may be located on an augmented reality server 373 discussed below.

Every instance need not necessarily have every feature depicted in FIG. 4. For example, any device with a digital camera can be a source of digital images handled by one or more embodiments of the disclosure, regardless of the presence of the other features. Furthermore, a device used to access server 306, discussed below, need not necessarily have a digital camera, but could be used in connection with digital photographs from other sources.

One or more embodiments provide techniques for matching an individual's personal photo images with the individual's purchase history. Images are captured and stored across devices such as cameras and smartphones. A consumer's transaction record is aligned to the image timestamps. The images are reshuffled according to purchase history, and merchants are matched to photos. Matching is carried out, for example, based on geolocation, and/or by time and date matching.

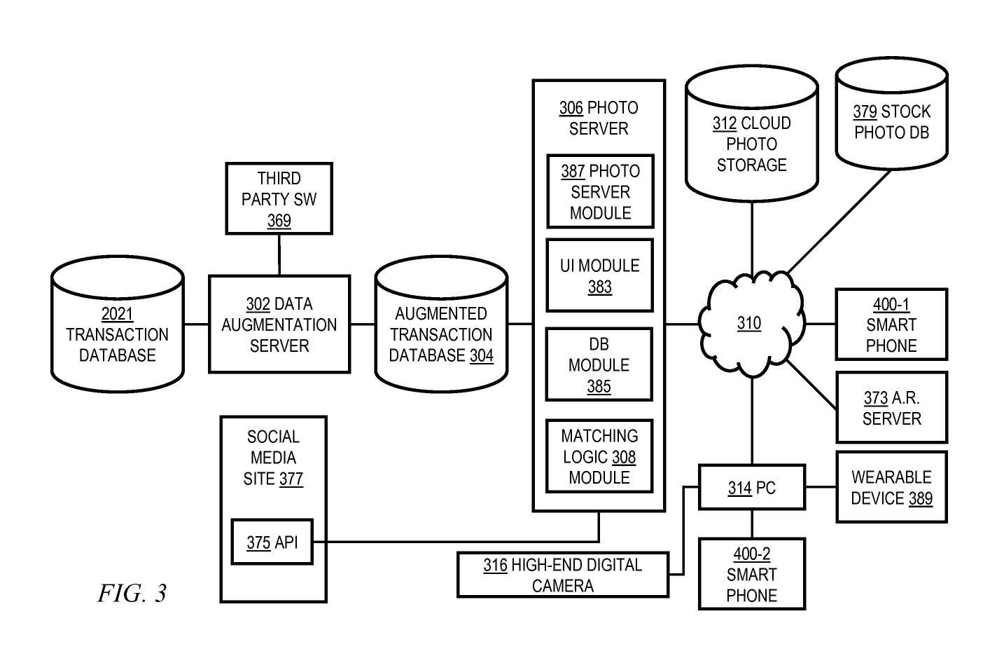

Referring now to FIG. 3, one or more embodiments match the consumer's personal photo images across a variety of places that the consumer can store his or her photos: e.g., smart phone 400, cloud storage 312, personal computer (PC) 314, and/or high-end digital camera 316. Please note reference character “400” refers generally to smart phone 400 of FIG. 4 and individual smart phones 400-1 and 400-2 of FIG. 3. When it is desired to refer to only one specific one of the smart phones, the particular reference character 400-1 or 400-2 is used. One or more embodiments bring together the person's personal photos and match them up with transaction data (e.g. from transaction database 2021 augmented by data augmentation server 302 to obtain augmented transaction database 304 as discussed below). One or more embodiments use matching logic 308 on a photo server 306 to match the time and/or location of one or more of the photos on camera 316, phones 400, PC 314, wearable device 389, and/or cloud storage 312 with one or more transactions in database 2021 and/or 304. For example, an individual may have been on a vacation during a certain time period, and one or more embodiments function as a photo sorting generator.

In one or more embodiments, a database such as database 2021 within a payment card network such as network 2008 keeps track of all the transactions that occur. There is a record for each transaction including the PAN or similar payment card account number, merchant ID and/or geographic location, a time stamp (including date and time), amount, and the like. In one or more embodiments, the merchant ID, time, date, and geographic location are parameters of interest.

In one or more embodiments, within database 2021, the time and date are available in the timestamp associated with each transaction record. Location IDs are included which identify particular terminals at points-of-sale 146, 148. In one or more embodiments, these location IDs are “scrubbed” based on acquirer information in order to determine an actual merchant location. For example, the operator of a payment card network such as network 2008 obtains acquirer information from merchants 2004. From this acquirer information, the operator of a payment card network such as network 2008 knows that certain terminals are linked to a particular merchant.

One or more embodiments use data augmentation server 302 to “scrub” and augment the raw data in database 2021, to translate the location (terminal) IDs from the raw data into actual merchant (and thus, geographical) locations. In some cases, longitude and latitude are embedded in the transaction data at the point of sale. In other cases, longitude and latitude are determined based on terminal ID or the like; e.g., via a third party application 369 as discussed in the next paragraph. The raw data in database 2021 can include, for example, for each transaction, the PAN, amount, a time stamp, terminal ID, merchant identifier, and/or merchant category code (MCC). In one or more embodiments, server 302 looks up transactions for a specific PAN for a person of interest. Optionally, a data verification process can be carried out to clean up “fuzzy” merchant and/or acquirer data. Data scrubbing techniques per se are known to the skilled artisan; given the teachings herein, the skilled artisan will be able to adapt one or more known data scrubbing techniques, if needed in a given case, to implement one or more embodiments of the invention.

Some embodiments employ third party software 369 on and/or in association with data augmentation server 302 to translate from Terminal ID in database 2021 to merchant name database 304. One example of such third party software is D&B Customer Integration Manager (D&B CIM) software available from Dun and Bradstreet (D & B), Short Hills, N.J., USA. Similar software is available from Pitney Bowes Inc., Stamford, Conn., USA. The skilled artisan will be familiar with this type of software per se, and, given the teachings herein, will be able to adapt same to implement one or more embodiments of the invention.

Still referring to FIG. 3, consider the generation and storage of digital photos. Digital photos are typically time and date stamped regardless of whether taken by a “smart” phone 400, wearable device 389, or high-end digital camera 316. Some photos may also have a geolocation; e.g., from GPS unit 499 in smart phone 400. High-end digital cameras 316 may be less likely to provide a geolocation for photos. Digital photos may reside in cloud-based photo storage 312 (e.g., Flickr® image hosting service, registered mark of Yahoo! Inc., Sunnyvale, Calif. USA), having been uploaded to same from smart phones 400 or high-end digital camera 316 (or other devices such as tablets, wearable device 389, or the like), via Internet 310 or other suitable network connectivity, directly or indirectly via PC 314. Digital photos may also reside on high-end digital camera 316, which may be coupled to PC 314 by a USB cable or the like; on smart phone 400-2, which may be coupled to PC 314 by a USB cable or the like; on PC 314; or on smart phone 400-1, which may have network connectivity to storage 312 via 3G or 4G cellular connections or the like. Digital photos may also reside on detachable memory cards or other memory devices of phones or cameras, which cards or other devices can be plugged in to PC 314 or the like.

The stored digital photos are, in essence, linked to an individual by being located on his or her smart phone 400, camera 316, PC 314, wearable device 389, or by being stored in cloud storage 312 in association with such individual. One or more embodiments link these photos with the transaction database(s) 2021 and/or 304. Again, the stored photos typically have a timestamp with the time and date, and perhaps a geo-location.

One or more embodiments provide a service to a consumer who wishes to tag his or her photos. The consumer uses a browser on his or her PC 314 to access a web application on photo server 306. The consumer enters his or her PAN or other payment card account number, which allows server 306 to access the corresponding augmented transaction records in database 304. The consumer also provides photo server 306 with the location of his or her photos—the directory on PC 314 or attached device 316, 400-2, 389, or the cloud location 312. The customer could also use a browser on a tablet or smart phone 400-1.

Matching logic 308 matches transactions in database(s) 2021, 304 with photos in locations 314, 316, 312, 389, 400. Some embodiments employ time and date matching; generally, some type of tolerance or “fuzzy” pattern matching is employed. That is to say, a transaction need not have been conducted at exactly the same time and/or place as a photo was taken in order for there to be a match. Where available, geo-location information for the photos can be used to supplement the time and date information (or possibly in lieu of same). In some cases, the logic 308 on server 306 generates putative locations and queries the user to confirm them, for example, “Did you take this photo number IMG-2014-0055 at the Empire State Building?” One or more embodiments apply “geofencing” (a virtual perimeter) around the location from the transaction data, to connect the pictures to the transaction.

Furthermore with regard to a tolerance-type approach, in some embodiments, consider all transactions within a certain time range (e.g., +/−two hours) around the time a date of a photo. Determine the location of each transaction, and ask the person if the photo was taken there. For example, suppose a person visited New York and took a certain photo at 2 PM on May 1, 2014. Suppose in the window from 12 noon to 4 PM on May 1, 2014, the person shows three card transactions, one for the South Street Seaport, one for the Empire State Building gift shop, and one for a horse-drawn carriage ride in Central Park. Logic 308 on server 306 causes server 306 to display on PC 314 the corresponding photo, and the user is queried: “Did you take this on the Staten Island Ferry?” “Did you take this at the Empire State Building?” “Did you take this during the carriage ride in Central Park?” Of course, if the user answers “yes” to any of the queries, the remaining queries need not be made.

A similar approach is used for geolocation, when available. A radius of predetermined size can be drawn about the geolocation of the photo (forming a virtual perimeter), and the person queried for any transactions that occurred within that virtual perimeter. Some embodiments use both time and geolocation; for example, offering the user a putative choice only when it resides within an appropriate geographic and time window.

It will be appreciated that transaction data may have an embedded longitude and latitude, or the longitude and latitude may be determined from the terminal ID or the like as discussed above. Many digital pictures, such as those taken by smart phone cameras, have longitude and latitude data available. A geofencing process is carried out around the transaction location, and it is determined whether any photos taken in the geo-fenced area are associated with the transaction. Alternatively, a geo-fencing process is carried out around the digital picture location, and it is determined whether any transactions that occurred in the geo-fenced area are associated with the digital picture. In another alternative, and/or in conjunction with the geo-fencing, a “time fencing” approach can be taken, looking at a time window including the transaction time (say, plus or minus a certain predetermined amount of time before and after the transaction time). Appropriate values for the geographic radius and length of the time slot can be determined empirically by seeing how well meaningful choices can be presented to the user. In a purely non-limiting example, starting value can be a radius of 1-2 miles and a time window of plus or minus ½ hour. Again, these are non-limiting exemplary starting values. Tests can be carried out on a corpus of data to see how often the user is presented with meaningful choices based on the initial values. If too many wrong choices are presented, the time and/or geographic radius is too big; conversely, if not enough meaningful choices are presented, the time and/or geographic radius is too small. In at least some instances, rural areas should have a larger geofence than urban areas. For example, a starting radius of 5 miles might be taken for rural regions in some instances.

Thus, it will be appreciated that when consumers venture to faraway places, they may have no recollection of where certain pictures were taken. Typically, travelling to multiple destinations over a week or longer results in not knowing where pictures were taken. One or more embodiments advantageously link images taken from devices such as cameras, smartphones, wearable devices, tablets, and the like, saved in a cloud or within the device, to transaction data. One or more embodiments match the timestamp of a picture to the timestamps of transactions to estimate what locations certain pictures were taken in. One or more embodiments advantageously eliminate the need to hashtag, geo-tag, or otherwise try to manually sort through a large number of pictures based on unaided recollection. Matching transaction data such as merchant name, location, latitude and longitude, time and date, and the like, against time and geolocation of images, enables consumers to arrange their photos or smartphone images in a more organized fashion. This also allows photos across multiple devices to be organized more efficiently.

One or more embodiments advantageously allow photos across multiple devices to be organized more efficiently. Current social media applications typically do not allow photo tagging to be reordered; such tagging is based on the time the photo was tagged. One or more embodiments allow alternative tagging or sequencing in a more logical manner than the current enforced time sequence. For example, one or more embodiments allow association of digital photos with certain users, human photo subjects, and/or locations.

Some embodiments are not limited to user-taken digital photos. For example, in some instances, matching may be carried out to link transactions to photos on web sites, which photos were not taken by the user—as an initial option and/or to substitute for a user-taken photo that did not turn out well. The non-user photos could be public domain photos or even photos available for licensed purchase.

Furthermore, digital photos may come from many different source besides cell phones and digital cameras—non-limiting examples include wearable cameras (e.g. on a necklace) that, for example, take a snapshot every 3-5 minutes, and/or the “Google Glass” product from Google Inc., Mountain View, Calif., USA. These kinds of devices are generally depicted as wearable device 389. These kinds of devices may interface with a PC such as 314 via a USB cable or the like and/or may have their own wireless network connections.

Even further, some embodiments give the user an option to make tagged photos available to other suitable people—for example, people who were along on a trip when the photo was taken, as determined from connection on social media. The pictures can then appear in the other people's social media (e.g., FACEBOOK® timelines—registered mark of Facebook, Inc., Menlo Park, Calif., US). For example, social media site 377 may expose an API 375 to photo server 306 to allow server 306 to identify related individuals on site 377 so that the tagged photos can be made available to them.

Some embodiments also include altitude in the geo-location. This can be useful, for example, if shopping in a store in a tall building—adding in the altitude allows determining what floor the user was on.

One or more embodiments might be useful in security applications. For example, suppose “John Smith” is in the Empire State Building and he is falsely accused of shoplifting in a nearby store. One or more embodiments could be used to prove his innocence by showing that he was elsewhere at the time. Some embodiments can also pair pictures together in an augmented reality world. Suppose an individual is looking out of the Empire State Building. Some embodiments collect pictures taken in the same spot by other people. There are smart phone applications that recognize a building in a picture and provide information about the surroundings.

### Recapitulation

Given the discussion thus far, it will be appreciated that, in general terms, an exemplary method, according to an aspect of the disclosure, includes the step of obtaining, at a photo server 306, from a cardholder, a payment card account number. This step can be carried out, for example, with a photo server module 387, embodied on a non-transitory computer-readable storage medium, executing on at least one hardware processor, such as hardware processor 520 (discussed below) of a photo server 306. A further step includes obtaining access, at the photo server, to a database 304 and/or 2021 of payment card transaction information, using the payment card account number. This step can be carried out, for example, with a database module 385, embodied on a non-transitory computer-readable storage medium, executing on the at least one hardware processor.

A still further step includes putatively matching at least one digital photo to a location of at least one transaction for the payment card account number in the database of transaction information, based on at least one of time stamp and geolocation, to obtain a first putative match. This step can be carried out, for example, with a matching logic module 308, embodied on a non-transitory computer-readable storage medium, executing on the at least one hardware processor. An even further step includes providing to the cardholder an indication of the first putative match. This step can be carried out, for example, at least in part with the matching logic module, embodied on the non-transitory computer-readable storage medium, executing on the at least one hardware processor. For example, the matching logic module can generate the indication of the first putative match, and optionally, a user interface module 383 serves out HTML (hypertext markup language) code to a browser on PC 314, phone 400-1, or the like to provide the indication to the cardholder.

In general, the digital photos that are matched can be still photos or videos, so long as at least one of time stamping and geographic location is available for purposes of matching with transactions.

In some cases, an additional step includes obtaining, at the photo server 306, from the cardholder, a link to digital photos taken by the cardholder. The digital photos can reside, for example, on high-end digital camera 316, smart phone 400-1 or 400-2, PC 314, wearable device 389, and/or cloud photo storage 312. The at least one digital photo putatively matched to the location is one of the digital photos at the link.

In some cases, an additional step includes obtaining, at the photo server 306, a response of the cardholder to the indication of the first putative match. In some such cases, a further step includes tagging the at least one of the digital photos taken by the cardholder with the first putative match, if the response of the cardholder is affirmative. The tagging can be carried out, for example, by matching logic 308. Furthermore, in some such cases, if the response of the cardholder is negative, further steps include putatively matching the at least one of the digital photos taken by the cardholder to another location of at least one transaction for the payment card account number in the database of transaction information, based on at least one of time stamp and geolocation, to obtain a second putative match; and providing to the cardholder an indication of the second putative match. These repeated steps can be carried out in the same manner as described above.

In some cases, further steps include identifying at least one alternative digital photo, from a source other than the cardholder (e.g., a stock photo database 379 accessible to server 306 by network 310 or otherwise), similar to the at least one digital photo putatively matched to the location; and offering to the cardholder an opportunity to obtain access to the at least one alternative digital photo.

In some cases, photos from a source other than the cardholder may be made available ab initio rather than as alternatives to photos taken by the cardholder. Thus, in some cases, in the step of putatively matching the at least one digital photo to the location of the at least one transaction, the at least one digital photo is from a source (e.g., 379) other than the cardholder.

In some embodiments, the step of putatively matching the at least one digital photo to the location of the at least one transaction is carried out at least based on geolocation; in some such cases, the geolocation includes latitude, longitude, and altitude. Altitude can be determined, for example, via GPS (e.g., module 499) or by a barometer-equipped smart phone (see barometer/pressure sensor 441) with a suitable application 443, for example. The altitude so determined can be stored in association with pictures taken by phone 400, for example.

Some instances further afford the cardholder an option to make the at least one digital photo putatively matched to the location available to a person linked to the cardholder via a social media web site. For example, social media web site 377 exposes an API 375 to photo server 306.

In some embodiments, a further step includes using at least one digital photo in an augmented reality application for the cardholder, based on the first putative match. The digital photo used in the augmented reality application based on the first putative match could be the digital photo that is putatively matched to the location of the at least one transaction, or could be a different digital photo. The digital photo used in the augmented reality application based on the first putative match could be one taken by the cardholder, or one not taken by the cardholder; e.g., from database 379. The augmented reality application 445 could reside, for example, on the smart phone 400-1; data for the application could reside on the smart phone 400-1 and/or on an augmented reality server 373 to which smart phone 400-1 connects via a high-bandwidth cellular connection, Wi-Fi, or the like.

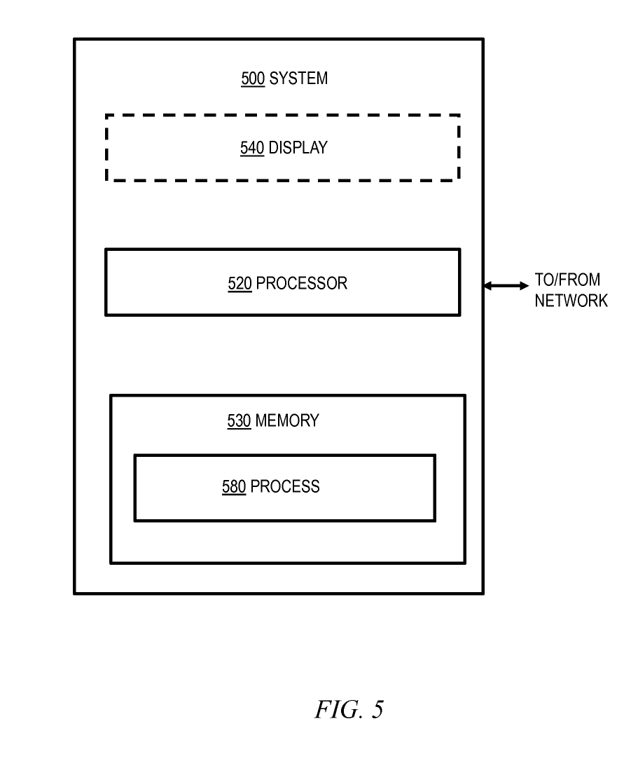

In another aspect, an exemplary photo server apparatus includes a memory 530; at least one processor 520 operatively coupled to the memory; and a persistent storage device operatively coupled to the memory and storing in a non-transitory manner instructions which when loaded into the memory cause the at least one processor to be operative to carry put or otherwise facilitate any one, some, or all of the method steps described herein. In at least some cases the persistent storage device stores distinct software modules as described elsewhere herein. Refer to the discussion of FIG. 5 below.

As noted, in some cases, an exemplary apparatus includes means for carrying the method steps described herein. Means for obtaining, from the cardholder, the payment card account number can include the photo server module 387 executing on at least one hardware processor 520. The specific algorithm for the photo server module includes the logic described in prose herein. Means for obtaining access to the database 2021 and/or 304 of payment card transaction information, using the payment card account number can include the database module 385 executing on the at least one hardware processor. The specific algorithm for the database module includes the queries described in prose herein. Means for putatively matching at least one digital photo to the location of at least one transaction for the payment card account number in the database of transaction information, based on at least one of time stamp and geolocation, to obtain the first putative match, include the matching logic module 308, executing on the at least one hardware processor. The specific algorithm for the matching logic module includes the logic described in prose herein. Exemplary means for providing to the cardholder an indication of the first putative match include at least the matching logic module executing on the at least one hardware processor, and optionally the user interface module 383 as well. The user interface module can optionally produce output. The user interface module can include, in some cases, an API when one or more techniques disclosed herein are offered as a service to a third party who accesses the API. In another aspect, the module can include a graphical user interface (GUI), such as that formed by a server (e.g., 306) serving out hypertext markup language (HTML) code to a browser of a user (e.g., on PC 314, smart phone 400-1, or other device).

### System and Article of Manufacture Details

Embodiments of the disclosure can employ hardware and/or hardware and software aspects. Software includes, but is not limited to, firmware, resident software, microcode, etc. Software might be employed, for example, in connection with one or more of matching logic 308 and/or other software modules discussed herein; a terminal 122, 124, 125, 126; a reader module 132; a host, server, and/or processing center 140, 142, 144 (optionally with data warehouse 154) of a merchant, issuer, acquirer, processor, or operator of a network 2008, operating according to a payment system standard (and/or specification); and the like. Firmware might be employed, for example, in connection with payment devices such as cards 102, 112, as well as reader module 132.

FIG. 5 is a block diagram of a system 500 that can implement part or all of one or more aspects or processes of the disclosure. As shown in FIG. 5, memory 530 configures the processor 520 (which could correspond, e.g., to processor portions 106, 116, 130; a processor of a terminal or a reader module 132; processors of remote hosts in centers 140, 142, 144; processors of hosts and/or servers implementing various functionality such as servers 302, 306, 373; processors of PC 314, device 389, phones 400, and the like); to implement one or more aspects of the methods, steps, and functions disclosed herein (collectively, shown as process 580 in FIG. 5). Different method steps can be performed by different processors. The memory 530 could be distributed or local and the processor 520 could be distributed or singular. The memory 530 could be implemented as an electrical, magnetic or optical memory, or any combination of these or other types of storage devices (including memory portions as described above with respect to cards 102, 112; phones 400, device 389, and camera 316). It should be noted that if distributed processors are employed, each distributed processor that makes up processor 520 generally contains its own addressable memory space. Thus, memory 530 includes on-processor memory, read-only memory (ROM), random access memory (RAM) and persistent storage such as hard drives and other non-transitory storage media discussed herein. It should also be noted that some or all of computer system 500 can be incorporated into an application-specific or general-use integrated circuit. For example, one or more method steps could be implemented in hardware in an ASIC rather than using firmware. Display 540 is representative of a variety of possible input/output devices (e.g., displays, printers, keyboards, mice, touch pads, and so on).

As is known in the art, part or all of one or more aspects of the methods and apparatus discussed herein may be distributed as an article of manufacture that itself comprises a tangible computer readable recordable storage medium having computer readable code means embodied thereon. The computer readable program code means is operable, in conjunction with a computer system, to carry out all or some of the steps to perform the methods or create the apparatuses discussed herein. A computer-usable medium may, in general, be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic medium or height variations on the surface of a compact disk. The medium can be distributed on multiple physical devices (or over multiple networks). For example, one device could be a physical memory media associated with a server and another device could be a physical memory media associated with a PC, smart phone, camera, processing center, or the like. As used herein, a tangible computer-readable recordable storage medium is defined to encompass a recordable medium (non-transitory storage), examples of which are set forth above, but does not encompass a transmission medium or disembodied signal.

The computer systems and servers described herein each contain a memory that will configure associated processors to implement the methods, steps, and functions disclosed herein. Such methods, steps, and functions can be carried out, by way of example and not limitation, by processing capability on one, some, or all of elements 122, 124, 125, 126, 140, 142, 144, 402, 2004, 2006, 2008, 2010; on a server 302, 306 interacting with database 2021 and/or 304; on server 373, wearable device 389, PC 314, a server or other computing machine implementing site 377, and the like. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the disclosure, such as, for example, 122, 124, 125, 126, 140, 142, 144, 402, 2004, 2006, 2008, 2010; on a server 302, 306 interacting with database 2021 and/or 304; on server 373, wearable device 389, PC 314, a server or other computing machine implementing site 377, and the like, can make use of computer technology with appropriate instructions to implement method steps described herein. Some aspects can be implemented, for example, using one or more servers which include a memory and at least one processor coupled to the memory. The memory could load appropriate software. The processor can be operative to perform one or more method steps described herein or otherwise facilitate their performance.

Accordingly, it will be appreciated that one or more embodiments of the disclosure can include a computer program comprising computer program code means adapted to perform one or all of the steps of any methods or claims set forth herein when such program is run on a computer, and that such program may be embodied on a computer readable medium. Further, one or more embodiments of the present disclosure can include a computer comprising code adapted to cause the computer to carry out one or more steps of methods or claims set forth herein, together with one or more apparatus elements or features as depicted and described herein.

As used herein, including the claims, a “server” includes a physical data processing system (for example, system 500 as shown in FIG. 5) running a server program. It will be understood that such a physical server may or may not include a display, keyboard, or other input/output components. A “host” includes a physical data processing system (for example, system 500 as shown in FIG. 5) running an appropriate program. Thus, photo server 306 is at least one physical computing device (which may or may not have a hypervisor or other virtualization layer on top) which runs, inter alia, software including photo server module 387.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components shown in the figures. In one or more embodiments, the modules include photo server module 387, user interface module 383, database module 385, and matching logic module 308. Database(s) 2021, 304 are stored in non-volatile (persistent) memory such as a hard drive and accessed by a suitable database management system (DBMS) such as database module 385 (similar DBMS functionality can also be provided on data augmentation server 302, for example). Interaction with a user can be provided via UI module 383 communicating with a device of the user, such as PC 314 or smart phone 400-1, for example. The method steps can then be carried out using the distinct software modules of the system, as described above, executing on the one or more hardware processors. Further, a computer program product can include a tangible computer-readable recordable storage medium with code adapted to be executed to carry out one or more method steps described herein, including the provision of the system with the distinct software modules.

One example of user interface 383 is hypertext markup language (HTML) code served out by a server 306 or the like, to a browser of a computing device of a user. The HTML is parsed by the browser on the user's computing device to create a graphical user interface (GUI). Some embodiments may operate a service another entity and the UI 383 involves an application program interface (API) or the like that provides the other entity with visibility into the results of method; the user in such cases may interact, for example, with a GUI provided by the other entity.

Thus, aspects of the disclosure can be implemented, for example, by one or more appropriately programmed general purpose computers, such as, for example, servers or personal computers, located at one or more of the entities in the figures, as well as within the payment network 2008, as well as PC 314, tablets or smart phones 400, wearable device 389, servers 302, 306, and the like. Such computers can be interconnected, for example, by one or more of network 138, 2008, another virtual private network (VPN), the Internet, a local area and/or wide area network (LAN and/or WAN), via an EDI layer, USB or other cabling, and so on. Note that element 2008 represents both the network and its operator. The computers can be programmed, for example, in compiled, interpreted, object-oriented, assembly, and/or machine languages, for example, one or more of C, C++, Java, Visual Basic, COBOL, Assembler, Structured Query Language (SQL), and the like (an exemplary and non-limiting list), and can also make use of, for example, Extensible Markup Language (XML), known application programs such as relational database applications (e.g., IBM DB2® software available from International Business Machines Corporation, Armonk, N.Y., US; SAS® software available from SAS Institute, Inc., Cary, N.C., US; an in-database analytics package such as the DB Lytix package available from Fuzzy Logix, LLC Charlotte, N.C., USA), spreadsheets (e.g., MICROSOFT EXCEL® software available from Microsoft Corporation, Redmond, Wash., US), and the like. SQL or Structured Query Language is a special-purpose programming language designed for managing data held in a relational database management system (RDMS). SQL and RDMS are non-limiting examples of query techniques and database management systems, respectively. In addition to RDMS, graph databases such as the open-source Neo4J database program available from Neo4J.org can be used. A graph database stores data using a graph as the data structure, and is capable of elegantly representing any kind of data in a highly accessible way. The computers can be programmed to implement the logic and/or data flow depicted in the figures. In some instances, messaging and the like may be in accordance with the International Organization for Standardization (ISO) Specification 5583 Financial transaction card originated messages—Interchange message specifications and/or the ISO 20022 or UNIFI Standard for Financial Services Messaging, also incorporated herein by reference in its entirety for all purposes.

Although illustrative embodiments have been described herein with reference to the accompanying drawings, it is to be understood that those precise embodiments are non-limiting, and that various other changes and modifications may be made by one skilled in the art without departing from the scope or spirit of the disclosure.

What is claimed is:

1. A method comprising the steps of:
obtaining, at a photo server, from a cardholder, a payment card account number;
obtaining access, at said photo server, to a database of payment card transaction information, using said payment card account number;
putatively matching at least one digital photo to a location of at least one transaction for said payment card account number in said database of transaction information, based on at least one of time stamp and geolocation, to obtain a first putative match; and
providing to said cardholder an indication of said first putative match.

2. The method of claim 1, further comprising obtaining, at said photo server, from said cardholder, a link to digital photos taken by said cardholder, wherein said at least one digital photo putatively matched to said location comprises one of said digital photos at said link.

3. The method of claim 2, further comprising obtaining, at said photo server, a response of said cardholder to said indication of said first putative match.

4. The method of claim 3, further comprising tagging said at least one of said digital photos taken by said cardholder with said first putative match, if said response of said cardholder is affirmative.

5. The method of claim 3, further comprising, if said response of said cardholder is negative:
putatively matching said at least one of said digital photos taken by said cardholder to another location of at least one transaction for said payment card account number in said database of transaction information, based on at least one of time stamp and geolocation, to obtain a second putative match; and
providing to said cardholder an indication of said second putative match.

6. The method of claim 2, further comprising:
identifying at least one alternative digital photo, from a source other than said cardholder, similar to said at least one digital photo putatively matched to said location; and
offering to said cardholder an opportunity to obtain access to said at least one alternative digital photo.

7. The method of claim 1, wherein, in said step of putatively matching said at least one digital photo to said location of said at least one transaction, said at least one digital photo is from a source other than said cardholder.

8. The method of claim 1, wherein said step of putatively matching said at least one digital photo to said location of said at least one transaction is carried out at least based on said geolocation, and wherein said geolocation comprises latitude, longitude, and altitude.

9. The method of claim 1, further comprising affording said cardholder an option to make said at least one digital photo putatively matched to said location available to a person linked to said cardholder via a social media web site.

10. The method of claim 1, further comprising using at least one digital photo in an augmented reality application for said cardholder, based on said first putative match.

11. The method of claim 1, wherein:
said obtaining of said payment card account number is carried out with a photo server module, embodied on a non-transitory computer-readable storage medium, executing on at least one hardware processor;
said obtaining of said access to said database of payment card transaction information is carried out with a database module, embodied on a non-transitory computer-readable storage medium, executing on said at least one hardware processor;
said putative matching of said at least one digital photo to said location of said at least one transaction is carried out with a matching logic module, embodied on a non-transitory computer-readable storage medium, executing on said at least one hardware processor; and
said providing to said cardholder of said indication of said first putative match is carried out, at least in part, with said matching logic module, embodied on said non-transitory computer-readable storage medium, executing on said at least one hardware processor.

12. A photo server apparatus comprising:
a memory;
at least one processor operatively coupled to said memory; and
a persistent storage device operatively coupled to said memory and storing in a non-transitory manner instructions which when loaded into said memory cause said at least one processor to be operative to:
obtain, from a cardholder, a payment card account number;
obtain access to a database of payment card transaction information, using said payment card account number;
putatively match at least one digital photo to a location of at least one transaction for said payment card account number in said database of transaction information, based on at least one of time stamp and geolocation, to obtain a first putative match; and
provide to said cardholder an indication of said first putative match.

13. The photo server apparatus of claim 12, wherein said persistent storage device further stores in said non-transitory manner instructions which when loaded into said memory cause said at least one processor to be further operative to obtain, from said cardholder, a link to digital photos taken by said cardholder, wherein said at least one digital photo putatively matched to said location comprises one of said digital photos at said link.

14. The photo server apparatus of claim 13, wherein said persistent storage device further stores in said non-transitory manner instructions which when loaded into said memory cause said at least one processor to be further operative to obtain a response of said cardholder to said indication of said first putative match.

15. The photo server apparatus of claim 14, wherein said persistent storage device further stores in said non-transitory manner instructions which when loaded into said memory cause said at least one processor to be further operative to tag said at least one of said digital photos taken by said cardholder with said first putative match, if said response of said cardholder is affirmative.

16. The photo server apparatus of claim 14, wherein said persistent storage device further stores in said non-transitory manner instructions which when loaded into said memory cause said at least one processor to be further operative to, if said response of said cardholder is negative:
putatively match said at least one of said digital photos taken by said cardholder to another location of at least one transaction for said payment card account number in said database of transaction information, based on at least one of time stamp and geolocation, to obtain a second putative match; and
provide to said cardholder an indication of said second putative match.

17. The photo server apparatus of claim 13, wherein said persistent storage device further stores in said non-transitory manner instructions which when loaded into said memory cause said at least one processor to be further operative to:
identify at least one alternative digital photo, from a source other than said cardholder, similar to said at least one digital photo putatively matched to said location; and
offer to said cardholder an opportunity to obtain access to said at least one alternative digital photo.

18. The photo server apparatus of claim 12, wherein said at least one digital photo is from a source other than said cardholder.

19. The photo server apparatus of claim 12, wherein said putative matching of said at least one digital photo to said location of said at least one transaction is carried out at least based on said geolocation, and wherein said geolocation comprises latitude, longitude, and altitude.

20. The photo server apparatus of claim 12, wherein said persistent storage device further stores in said non-transitory manner instructions which when loaded into said memory cause said at least one processor to be further operative to afford said cardholder an option to make said at least one digital photo putatively matched to said location available to a person linked to said cardholder via a social media web site.

21. The photo server apparatus of claim 12, wherein said persistent storage device further stores in said non-transitory manner instructions which when loaded into said memory cause said at least one processor to be further operative to designate at least one digital photo for use in an augmented reality application for said cardholder, based on said first putative match.

22. The photo server apparatus of claim 12, wherein:
said instructions on said persistent storage device comprise a photo server module, a database module, and a matching logic module;
said at least one processor is operative to obtain said payment card account number by executing said photo server module;
said at least one processor is operative to obtain said access to said database of payment card transaction information by executing said database module;
said at least one processor is operative to putatively match said at least one digital photo to said location of said at least one transaction by executing said matching logic module; and
said at least one processor is operative to provide to said cardholder said indication of said first putative match, at least in part, by executing said matching logic module.

23. An article of manufacture comprising a non-transitory computer-readable storage medium storing instructions which when executed by a processor cause said processor to be operative to:
obtain, from a cardholder, a payment card account number;
obtain access to a database of payment card transaction information, using said payment card account number;
putatively match at least one digital photo to a location of at least one transaction for said payment card account number in said database of transaction information, based on at least one of time stamp and geolocation, to obtain a first putative match; and
provide to said cardholder an indication of said first putative match.

24. An apparatus comprising:
means for obtaining, from a cardholder, a payment card account number;
means for obtaining access to a database of payment card transaction information, using said payment card account number;
means for putatively matching at least one digital photo to a location of at least one transaction for said payment card account number in said database of transaction information, based on at least one of time stamp and geolocation, to obtain a first putative match; and
means for providing to said cardholder an indication of said first putative match.
